(19) United States
(12) Patent Application Publication
(10) Pub. No.: US 2026/0207412 A1
(43) Pub. Date: Jul. 23, 2026

(54) TENDON-DRIVEN WEARABLE ORTHOSIS AND METHOD FOR CALIBRATING A TENDON-DRIVEN WEARABLE ORTHOSIS

(71) Applicant: Universität Heidelberg, Heidelberg (DE)

(72) Inventors: Maximilian Morgalla, Eppelheim (DE); Ryan Alicea, Heidelberg (DE); Lorenzo Masia, Heidelberg (DE)

(73) Assignee: Universität Heidelberg, Heidelberg (DE)

(21) Appl. No.: 19/141,991

(22) PCT Filed: Dec. 20, 2023
(86) PCT No.: PCT/EP2023/087014

§ 371 Date: Jun. 20, 2025

(30) Foreign Application Priority Data
Dec. 21, 2022 (EP) 22215694.5

(51) Int. Cl. A61H 1/02; B25J 9/00; B25J 9/10

(52) U.S. Cl. CPC A61H 1/0288; B25J 9/0006; B25J 9/1045; A61H 2201/1215; A61H 2201/149

(57) ABSTRACT

The disclosure concerns a tendon-driven wearable orthosis configured to be worn by a user, wherein the tendon-driven wearable orthosis is configured to assist a movement of at least one joint of the user, comprising: an adapter unit connectable, via at least one tendon, to at least one end effector, wherein the adapter unit is releasably connectable to a motor unit, wherein the motor unit is configured to operate the adapter unit to exert a pulling force on the at least one tendon to assist the movement of the at least one joint, wherein the adapter unit comprises at least one tensioning device configured to adjustably control a length of the at least one tendon between the adapter unit and the at least one end effector. Furthermore, a method for calibrating a tendon-driven wearable orthosis configured to be worn by a user is disclosed.

The present invention relates to a tendon-driven wearable orthosis and a method for calibrating a tendon-driven orthosis.

The invention lies in the field of user wearable orthoses, and in particular in the field of tendon-driven wearable orthoses. Specifically, members of a population suffering from some form of, for example, upper body paralysis from a stroke, spinal cord injury, brachial plexus injury, or other causes may struggle to perform certain movements, such as grasping movements normally executed by a hand. To aid in performing such movements or restoring the ability to perform said movements, different types of mechanical devices have previously been developed, such as powered glove devices to be worn on the hand of a user. The powered glove devices may be actuated using tendon-based and pneumatic systems.

Typically available tendon-based systems comprise an actuator connected to a glove structure via one or more tendons. Each tendon is of a fixed length and recovered and released by the actuator. It is therefore necessary to perform accurate measurements of the user to ensure accurate values for tendon lengths are determined. Subsequently, the tendons are cut to size and fixedly connected to the actuator and the glove structure. Failure to obtain accurate measurements may cause incorrect operation of the tendon-based system. For example, when an underactuated tendon-based system is used, inaccurate measurements may cause one or more fingers to flex/extend out of synchronisation, leading to an unnatural finger movement and/or failure to safely grasp objects.

In addition, the specific required lengths for each tendon are highly user-specific, such that a mass production of tendon-based systems is not possible. This may be avoided by providing separate tendons and corresponding separate actuators for each tendon. However, such an approach significantly increases power requirements, as well as system complexity, costs, mass, and size for the orthosis.

It is therefore an object of the invention, to provide a tendon-driven wearable orthosis with improved individualisation properties. The above object is solved by a tendon-driven wearable orthosis and a method of calibrating a tendon-driven wearable orthosis according to the independent claims. Preferred embodiments form the subject of the dependent claims.

An aspect of the disclosure relates to a tendon-driven wearable orthosis configured to be worn by a user. In particular, the tendon-driven wearable orthosis may be at least partially mountable on a harness, wherein the tendon-driven wearable orthosis and/or the harness may be configured to be worn by the user. The harness may comprise, for example, one or more belts and/or one or more bands. The harness may comprise at least one of one or more textiles, one or more plastics, one or more metals, and/or one or more composite materials. The harness may be a unitary harness or may comprise one or more distinct harness parts, such as for example belts and/or bands.

The tendon-driven wearable orthosis is configured to assist a movement of at least one joint of the user. A joint of a user may connect two or more structures, such as for example bones, of a skeletal system of the user. The tendon-driven wearable orthosis may be configured to assist the movement of the at least one joint by generating a direct and/or indirect force, such as a pulling force, on at least one structure to cause a movement, such as a bending movement, of the at least one joint of the user. The tendon-driven wearable orthosis may be configured to assist a movement of multiple joints of the user simultaneously, such as by assisting a bending motion of a finger and/or hand of the user.

The tendon-driven wearable orthosis comprises an adapter unit connectable, via at least one tendon, to at least one end effector. In particular, at least one tendon may be fixedly or releasably connectable to the adapter unit at a first end of the at least one tendon, and fixedly or releasably connectable to at least one end effector at a second end of the at least one tendon. Alternatively or additionally, at least one tendon may be configured as at least one closed loop tendon, wherein the at least one closed loop tendon may be fixedly or releasably connectable to the adapter unit and at least one end effector.

The at least one tendon may be at least one cable element, such as a metal cable. However, the tendon-driven wearable orthosis is not limited to such a type of tendon, and any type of tendon may be used. All of the at least one tendon may be formed from a substantially identical material, or different materials may be used. Furthermore, the term “tendon” is intended to be interpreted broadly herein, and may thus also encompass other elements suitable to connect the adapter unit to the at least one end effector. For example, the at least one tendon may alternatively or additionally comprise one or more of a band, a strap, a chain, a string, and/or a ribbon. Furthermore, the at least one tendon may be configured as at least one inner cable of at least one Bowden cable.

The at least one end effector may be configured to be worn by the user, such as for example on a hand and/or finger of a user. However, the tendon-driven wearable orthosis is not limited thereto, and may be used for other elements and/or joints of the user. The at least one end effector may be configured to be fixedly or releasably connectable to the at least one tendon. In particular, the at least one end effector may comprise one or more connection elements configured to be connectable to the at least one tendon, wherein the one or more connection elements may comprise one or more hooks, loops, and/or tendon guides. The at least one end effector may, for example, be configured to be mountable on a support structure, such as a glove structure, configured to be worn by the user. The tendon-driven wearable orthosis may further comprise at least one tendon guide element configured to guide the at least one tendon from the adapter unit to the at least one end effector and/or the support structure. The at least one tendon guide element may comprise a Bowden cable outer sheath, wherein each of the at least one tendon may be configured as inner cables positioned inside the Bowden cable outer sheath. The at least one tendon guide element may be fixedly connected, at a first end thereof, to the adapter unit, and fixedly connected, at a second end thereof, to the support structure. Specifically, it may therefore be possible to maintain a desired distance between the support structure and the adapter unit, while still allowing the length of the at least one tendon to be adjustably controlled to, for example, pre-tension said at least one tendon.

The adapter unit is releasably connectable to a motor unit. For example, the adapter unit may be mountable on and/or engageable with the motor unit. The motor unit is configured to operate the adapter unit to exert a pulling force on the at least one tendon to assist the movement of the at least one joint. In other words, the motor unit is configured to operate the adapter unit to generate the pulling force, wherein the pulling force is exertable on the at least one tendon to assist the movement of the at least one joint. For example, in a state in which the adapter unit is connected to the motor unit, the motor unit may be configured to generate a force, such as a mechanical force, on the adapter unit to cause the adapter unit to exert the pulling force. The pulling force exerted on the at least one tendon may be configured to cause, via the at least one tendon, a further pulling force to be exerted on the at least one end effector to assist the movement of the at least one joint. The motor unit may, for example, be configured as a linear actuator or a rotary actuator. The motor unit may be configured as a non-backdriveable motor unit. In other words, the motor unit may be configured to operate the adapter unit in one operating direction (e.g., forward or clockwise) instead of two operating directions (e.g., forward and backward, or clockwise and counter-clockwise). Specifically, a very simple design of the motor unit may thus become possible.

The adapter unit further comprises at least one tensioning device configured to adjustably control a length of the at least one tendon between the adapter unit and the at least one end effector. The at least one tensioning device may be configured to adjustably control the length of the at least one tendon to pre-tension the at least one tendon between the adapter unit and the at least one end effector. Adjustably controlling the length of the at least one tendon may in particular be understood as adjustably increasing and/or decreasing the length of the at least one tendon. It may therefore be possible to adjustably control the length of the at least one tendon to have a desired length.

Thereby the adapter unit may advantageously allow an efficient individualisation of the tendon-driven wearable orthosis to specific needs or parameters of the user, such as for each finger of the user separately. In particular, it may thus be possible to avoid having to perform significant measurements of the user even prior to producing the tendon-driven wearable orthosis in order to ensure an individual fit to the user. Furthermore, by providing such a tendon-driven wearable orthosis comprising the adapter unit, it may become possible to provide said tendon-driven wearable orthosis as a standardised product, which can efficiently and easily be adapted to the individual needs of the user. Specifically, mass production of the tendon-driven wearable orthosis may thus be achieved.

In addition, by providing a tendon-driven wearable orthosis comprising the adapter unit, the tendon-driven wearable orthosis may be dynamically adjusted to the user. Therefore, errors in measurements of the user can be prevented from causing a wrong fit and/or operation of the orthosis. In addition, the tendon-driven wearable orthosis may be adapted to potential physiological changes of the user.

The use of underactuation of the tendon-driven wearable orthosis may also be efficiently enabled. For example, the adapter unit and/or two or more tendons may be configured to be operable by a single actuator of a motor unit. Thereby, requirements of the motor unit may be significantly reduced (such as, for example, power, cost, complexity, mass, and size requirements), while still maintaining large degrees of freedom for any user. Flexibility of the tendon-driven wearable orthosis may further be improved by allowing the adapter unit to be efficiently attached to and removed from the motor unit.

Furthermore, by providing such a tendon-driven wearable orthosis, the tendon-driven wearable orthosis can be worn by one or more users, while allowing an individual fit to be obtained for each of said users as desired and/or required by a current wearer of the tendon-driven wearable orthosis.

The tendon-driven wearable orthosis may be configured to be at least partially worn on a hand and/or arm of the user. Specifically, the adapter unit may be connectable, via the at least one tendon, to the at least one end effector, wherein said at least one end effector may be configured to be worn and/or mounted on a hand and/or at least one finger of the user. Thereby, the adapter unit may be configured to exert the pulling force, via the at least one tendon and the at least one end effector, on at least one joint of the hand of the user. In particular, the tendon-driven wearable orthosis may be configured to assist a movement of at least one finger joint of a hand of the user. The movement of the at least one finger joint may be a flexion and/or extension of the at least one finger joint.

Therefore, the tendon-driven wearable orthosis may efficiently and easily assist the movement of the hand of the user, and may consequently support such a movement for users suffering from mobility issues of their hand or hands, due to for example a stroke.

In particular, the tendon-driven wearable orthosis may be configured to assist a substantially simultaneous movement of at least two finger joints of at least two of the index finger, the middle finger, the ring finger, the little finger, and/or the thumb. Specifically, by assisting such a substantially simultaneous movement, it may be possible to support grasping motions of the hand of the user very efficiently.

“Substantially” is to be understood, in the context of the present disclosure, as also comprising small deviations caused by, for example, environmental and/or construction/production reasons, unless a different definition is specifically provided.

The tendon-driven wearable orthosis may further comprise the at least one tendon and the at least one end effector. In particular, the tendon-driven wearable orthosis may comprise the adapter unit, the at least one tendon, and the at least one end effector, wherein the adapter unit is connected, via the at least one tendon, to the at least one end effector. It may therefore be possible to efficiently provide the tendon-driven wearable orthosis as a unit configured to be individually adjustable to the requirements of the user via, for example, the at least one tensioning device.

The Tendon-driven Wearable Orthosis May Further Also Comprise the Motor Unit.

The at least one tensioning device may be configured to adjustably control the length of the at least one tendon between the adapter unit and the at least one end effector while the adapter unit is not connected to the motor unit. In particular, it may therefore be possible to individually adjust the tendon-driven wearable orthosis to the user without requiring a connection to the motor unit. Therefore, an easier and simpler construction of both the motor unit and the adapter unit may be achieved. In addition, the process of adjusting the length of the at least one tendon may be further facilitated, as the adapter unit may be in a state separate from the motor unit.

The adapter unit may further comprise at least one first spool, wherein the at least one tendon may be connectable to the at least one first spool. In particular, the adapter unit may comprise one first spool for each tendon of the at least one tendon. Each tendon may be connectable to one respective first spool. Thereby, an efficient management of the at least one tendon in the tendon-driven wearable orthosis may be achieved. The at least one first spool is configured to be rotatable by the motor unit to exert the pulling force on the at least one tendon. In particular, the at least one first spool may be configured to be, in a state in which the adapter unit is connected to the motor unit, operatable by the motor unit to rotate around a corresponding rotation axis. Each first spool may have its own rotation axis, or one or more spools may share a common rotation axis. The at least one first spool may be configured such that the at least one tendon may be at least partially wound around the at least one first spool by rotation of the at least one first spool.

The at least one first spool may further comprise one or more spool bearings, such as one or more spool bearing washers. It is noted that while the provision of one or more spool bearings is described for the at least one first spool herein, it is to be understood that any spool described herein may further comprise one or more spool bearings.

The at least one tensioning device may comprise at least one first tensioning tool releasably engageable with the adapter unit and the at least one first spool. Releasably engageable is to be understood as encompassing being configured to be brought into engagement and being configured to be brought out of engagement, as desired, preferentially without causing substantial damages and/or deformations. Furthermore, the at least one first spool may be configured to be operable, preferentially rotatable, using the at least one first tensioning tool to control the length of the at least one tendon between the adapter unit and the at least one end effector. Preferentially, the at least one first spool may be configured to be rotatable using the at least one first tensioning tool to reduce the length of the at least one tendon between the adapter unit and the at least one end effector. Specifically, it may therefore be possible to very efficiently control the length of the at least one tendon, enabling an improved calibration of the tendon-driven wearable orthosis to the individual requirements of the user.

The at least one first tensioning tool may be at least one ratcheting key. The at least one ratcheting key may be configured to be operable to perform a ratcheting operation. In particular, each ratcheting key may comprise a plurality of first ratcheting teeth and the adapter unit may comprise a plurality of second ratcheting teeth.

Ratcheting teeth may be understood within this disclosure as comprising a series of, preferentially alternating, protrusions and recesses. The series of protrusions and recesses may respectively extend radially outward or inward with respect to a respective central axis of an element or structure comprising said series of protrusions and recesses. Ratcheting teeth, as described herein may be configured to be at least partially elastically deformable.

Each ratcheting key may be configured to be releasably engageable with the adapter unit and at least one first spool to bring the plurality of first ratcheting teeth into engagement with at least a subset of the plurality of second ratcheting teeth. The plurality of first ratcheting teeth and at least the subset of plurality of second ratcheting teeth may be configured to prevent rotation of the at least one first spool in a first rotation direction and allow rotation of the at least one first spool in a second rotation direction opposite to the first rotation direction, while the plurality of first ratcheting teeth is in engagement with at least the subset of plurality of second ratcheting teeth. In particular, the first rotation direction and the second rotation direction may correspond to opposite rotation directions around a central rotation axis of the at least one ratcheting key and/or the at least one first spool. Specifically, it may therefore be efficiently possible to reduce the length of the at least one tendon and maintaining such a reduced length of the at least one tendon using the at least one ratcheting key. This may allow the length of multiple tendons to be adjusted in sequence, without having to actively maintain any such tendons at the reduced and/or desired length, such as by holding the respective ratcheting key manually by the user. Furthermore, should a length of a tendon have accidentally been reduced too much and/or tensioned too tightly, the respective ratcheting key may simply be brought out of engagement with the adapter unit and the at least one first spool to allow the at least one first spool to rotate to correct said length.

The at least one tensioning device may further comprise a carriage movably mounted on a carriage track, wherein the carriage may be a spool carriage. The carriage or spool carriage may for example comprise a carriage body and at least one wheel element, wherein the at least one wheel element is fixed to the carriage body and configured to allow the carriage or spool carriage to be movable along the carriage track. The carriage track may comprise one or more guide rails, along which the carriage or spool carriage may be guided.

The at least one tensioning device may further comprise at least one connection device mounted on the carriage, wherein the at least one tendon may be connectable to the at least one connection device, wherein the carriage may be configured to be movable along the carriage track by the motor unit to exert the pulling force on the at least one tendon.

The at Least One Connection Device May Be Implemented As at Least One Second Spool, as further described below. However, the at least one connection device is not limited to such an implementation, and any at least one connection device configured to be connectable to the at least one tendon could be implemented. For example, the at least one connection device may be implemented as at least one adjustable clamp. Preferably such a clamp is configured to be operated with one hand, e.g. without a winding pulley, which enable to reduce the overall size of the connection. For example, a thumb screw can be tightened onto a clamping plate which holds the tendons in place at the correct relative lengths. Such operation might be performed by a technical during the initial fitting of the product, for example.

The at least one tensioning device may further comprise at least one second spool mounted on the spool carriage, wherein the at least one tendon is connectable to the at least one second spool. The at least one second spool may be mounted on the spool carriage to be rotatable around a central rotation axis of the at least one second spool. Furthermore, the at least one second spool may be configured such that the at least one tendon may be at least partially wound around the at least one second spool by rotation of the at least one second spool. The spool carriage may further be configured to be movable along the carriage track by the motor unit to exert the pulling force on the at least one tendon.

In particular, it may therefore be possible to efficiently cause the pulling force to be exerted using, for example, a linear actuator configured to move the carriage or spool carriage along the carriage track.

The spool carriage may further comprise a plurality of third ratcheting teeth. In particular, the plurality of third ratcheting teeth may be provided in the spool carriage body of the spool carriage. The at least one second spool may comprise a plurality of fourth ratcheting teeth releasably engageable with at least a subset of the plurality of third ratcheting teeth. The plurality of fourth ratcheting teeth and at least the subset of plurality of third ratcheting teeth may be configured to prevent rotation of the at least one second spool in a third rotation direction and allow rotation of the at least one second spool in a fourth rotation direction opposite to the third rotation direction, while the plurality of fourth ratcheting teeth is in engagement with at least the subset of plurality of third ratcheting teeth. In particular, the third rotation direction and the fourth rotation direction may correspond to opposite rotation directions around a central rotation axis of the at least one second spool. Specifically, it may therefore be efficiently possible to reduce the length of the at least one tendon and maintaining such a reduced length of the at least one tendon.

The at least one tensioning device may further comprise at least one second tensioning tool releasably engageable with the at least one second spool. In particular, the at least one second spool may be configured to be rotatable in the fourth direction using the at least one second tensioning tool to control the length of the at least one tendon between the adapter unit and the at least one end effector. For example, the at least one second tensioning tool may be configured to be engageable with at least one second spool and further comprise a rotation handle configured to allow the user to rotate the at least one second tensioning tool to cause a rotation of the at least one second spool.

The at least one second spool may be further configured to be operable using the at least one second tensioning tool to move the plurality of fourth ratcheting teeth out of engagement with at least the subset of the plurality of third ratcheting teeth. In particular, the at least one second spool may comprise at least one spring element. For example, the at least one second spool may be at least one second spring-loaded spool. The at least one spring element may be fixed at a first spring end to the spool carriage and/or the carriage body, and/or may be fixed at a second spring end to the at least one second spool. A compression direction of the at least one spring element may be substantially parallel to a central rotation axis of the at least one second spool. The at least one second tensioning tool may be operable to cause a pressing force on the at least one second spool to cause the at least one spring element to be compressed, thereby moving the plurality of fourth ratcheting teeth out of engagement with at least the subset of the plurality of third ratcheting teeth.

Thereby, a particularly efficient and easy to use means to adjustably control the length of the at least one tendon may be provided. A length of the at least one tendon may easily be reduced by engaging the at least one second tensioning tool with the at least one second spool and rotating said at least one second tensioning tool. In addition, should a length of a tendon have accidentally been reduced too much and/or tensioned too tightly, a pressing force may be exerted on the respective second tensioning tool, such as by the user, in order to cause the plurality of fourth ratcheting teeth to be brought out of engagement with at least the subset of the third ratcheting teeth. Thereby, the at least one second spool may be allowed to rotate in the third rotation direction to increase the length of the respective at least one tendon.

The at least one tensioning device may further comprise a multi-spool unit. The multi-spool unit may comprise at least a central rotation shaft and a plurality of third spools. Each of the third spools may be substantially identical to one another. The plurality of third spools may be mounted on the central rotation shaft. For example, each third spool may comprise a central mounting bore extending through the respective third spool, wherein the central rotation shaft is insertable into the central mounting bore. The at least one tendon may be connectable to the at least one third spool, wherein the at least one tendon may be configured to be wound around the at least one third spool during rotation of the at least one third spool. In particular, using such a multi-spool unit, it may be possible to efficiently and simultaneously exert the pulling force on the at least one tendon by rotation of the central rotation shaft.

Furthermore, the multi-spool unit may be configured to be switchable between a first state and a second state. In the first state, each of the plurality of third spools may be configured to be rotatable, preferentially freely rotatable, around the central rotation shaft. In the second state, the plurality of third spools may be configured to be fixed relative to the central rotation shaft. For example, in the second state, the plurality of third spools may be compressed between a top plate and a bottom plate of the multi-spool unit, wherein the top plate and the bottom plate may be engageable to and/or fixed relative to the central rotation shaft. Furthermore, in the second state, the multi-spool unit may be configured to be rotatable by the motor unit to exert the pulling force on the at least one tendon. Thereby a simple design and operation of the multi-spool unit may be achieved.

The at least one tensioning device may further comprise at least one third tensioning tool. The at least one third tensioning tool may be configured to be releasably engageable with the plurality of third spools in the first state to fix an orientation of the plurality of third spools relative to one another. For example, each of the plurality of third spools may comprise at least one locking bore extending through the respective third spool. The at least one third tensioning tool may be insertable into at least one locking bore of each third spool in order to fix the orientation of the plurality of third spools with respect to one another. In particular, it is therefore possible to rotate each of the third spools in the first state around the central rotation shaft into a desired respective orientation and then insert the at least one third tensioning tool into the respective at least one locking bores. Specifically, it is therefore possible to individually select a length for each tendon connected to a respective third spool. The at least one third tensioning tool may for example be at least one locking screw, wherein the at least one locking screw may be configured to be screwed into the top plate and/or the bottom plate. The at least one third tensioning tool may be removable from the multi-spool unit in the second state. Thereby, a simple and efficient means of adapting the multi-spool unit and thus the tendon-driven wearable orthosis to individual requirements of the user may be provided.

For example, each of the plurality of third spools may comprise eight locking bores extending through the respective third spool. However, the plurality of third spools are not restricted to such a number of locking bores, wherein the number of locking bores may be freely chosen according to the requirements of the tendon-driven wearable orthosis and/or the user. Specifically, by increasing the number of locking bores, more desired respective orientations and/or a higher precision of the multi-spool unit may be achievable. Furthermore, by reducing the number of locking bores, a structural stability of the multi-spool unit may be increased, in light of for example the materials used for the multi-spool unit, and therefore a failure chance of the multi-spool unit may be reduced. Therefore, the number of locking bores may be chosen by, for example, weighing such factors against one another and finding an acceptable compromise according to the requirements of the tendon-driven wearable orthosis and/or the user.

The adapter unit may further comprise a tensioning device for each one of the at least one tendon, wherein each tensioning device is configured to adjustably control the length of a respective tendon between the adapter unit and the at least one end effector. Alternatively, the adapter unit may comprise a tensioning device for a plurality of tendons or all of the tendons, wherein each tensioning device is configured to adjustably control the length of the respective tendons between the adapter unit and the at least one end effector.

The motor unit may be configured to operate the adapter unit to exert the pulling force on the at least two tendons substantially simultaneously to assist the movement of the at least one joint. Preferentially, the motor unit may be configured to operate the adapter unit to exert the pulling force on all tendons substantially simultaneously to assist the movement of the at least one joint, thereby efficiently allowing the tendon-driven wearable orthosis to assist, for example, a grasping motion of the user.

The adapter unit may be configured to be connectable to the motor unit and the at least one first tensioning tool, the at least one second tensioning tool, and/or the at least one third tensioning tool, respectively, at the same time. It may therefore be possible to maintain a desired length of the at least one tendon using the at least one first tensioning tool, the at least one second tensioning tool, and/or the at least one third tensioning tool, respectively, until the adapter unit is connected to the motor unit. Specifically, it may therefore be possible to avoid unwanted and/or unintentional changes in the length of one or more tendons during connection of the adapter unit with the motor unit.

A further aspect of the disclosure concerns a method for calibrating a tendon-driven wearable orthosis configured to be worn by a user, wherein the tendon-driven wearable orthosis is configured to assist a movement of at least one joint of the user. The tendon-driven wearable orthosis comprises an adapter unit connectable, via at least one tendon, to at least one end effector. The method comprises mounting the tendon-driven wearable orthosis on the user, and adjustably controlling, using at least one tensioning device of the adapter unit, a length of the at least one tendon between the adapter unit and the at least one end effector.

The step of adjustably controlling the length of the at least one tendon may further comprise releasably connecting at least one tensioning tool to the adapter unit. The at least one tensioning tool may, for example, be at least one first tensioning tool, at least one second tensioning tool, and/or at least one third tensioning tool, as described herein.

The step of adjustably controlling the length of the at least one tendon may further comprise operating, such as for example rotating and/or turning, using the at least one tensioning tool, the at least one tensioning device to control the length of the at least one tendon between the adapter unit and the at least one end effector.

In particular, the method for calibrating a tendon-driven wearable orthosis may comprise any combination of the features described herein for a tendon-driven wearable orthosis.

A further aspect of the disclosure relates to a method for assisting a movement of at least one joint of a user. The method comprises calibrating a tendon-driven wearable orthosis configured to be worn by the user. In particular, the step of calibrating the tendon-driven wearable orthosis may comprise performing the method for calibrating a tendon-driven wearable orthosis described herein. The method for assisting a movement of at least one joint of a user further comprises releasably connecting the adapter unit to a motor unit configured to operate the adapter unit to exert a pulling force on the at least one tendon to assist the movement of the at least one joint of the user and operating the adapter unit using the motor unit.

The step of releasably connecting the adapter unit may further comprise releasably connecting the adapter unit to the motor unit while the at least one tensioning tool is connected to the adapter unit, and disconnecting the at least one tensioning tool from the adapter unit. The at least one tensioning tool may, for example, be at least one first tensioning tool, at least one second tensioning tool, and/or at least one third tensioning tool, as described herein.

In particular, the method for assisting a movement of at least one joint of a user may comprise any combination of the features described herein for a tendon-driven wearable orthosis.

The invention will now be further discussed and explained by reference to exemplary embodiments illustrated in the appended Figures. It is to be understood that the invention is not limited to said exemplary embodiments, but instead may comprise any combination of features described herein and/or shown in the appended Figures.

The Figures show:

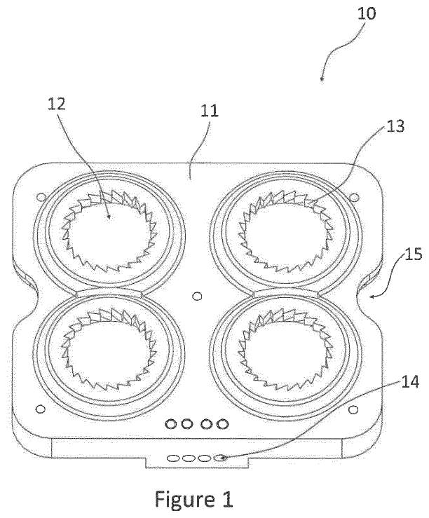

FIG. 1: a top view of an exemplary adapter top plate of an exemplary adapter unit;

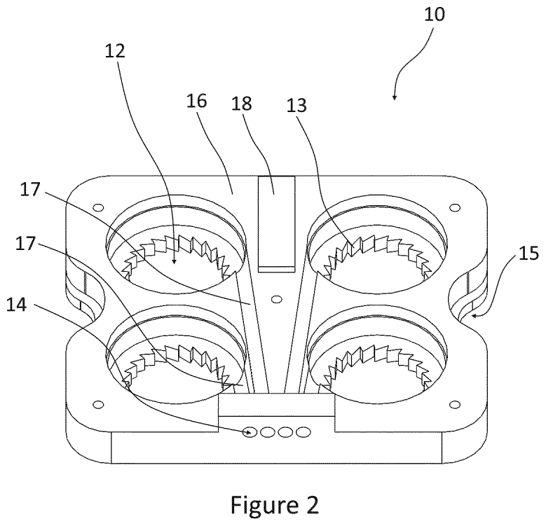

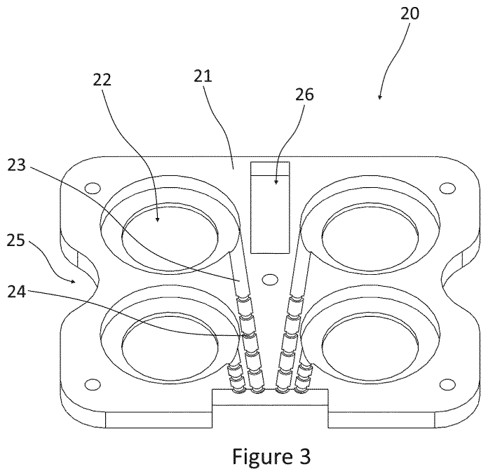

FIG. 2: a bottom view of an exemplary adapter top plate of an exemplary adapter unit;

FIG. 3: a top view of an exemplary adapter bottom plate of an exemplary adapter unit;

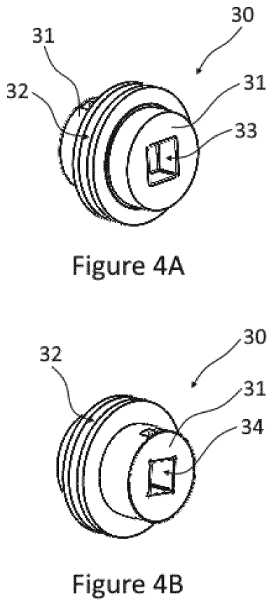

FIGS. 4A to 4B: a perspective view of an exemplary first spool from a front side and a back side, respectively;

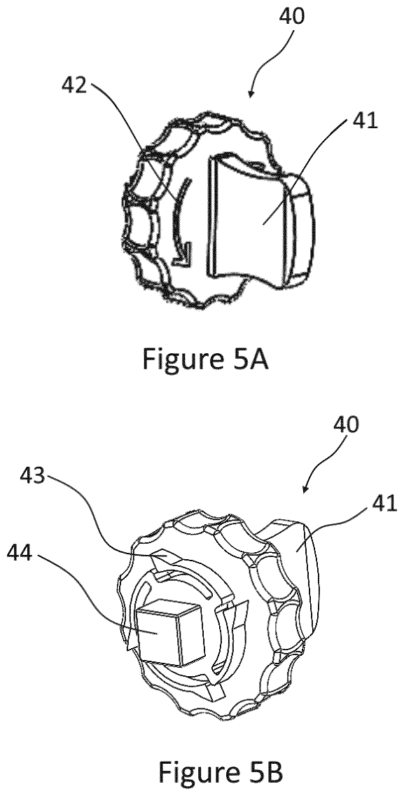

FIGS. 5A to 5B: a perspective view of an exemplary first tensioning tool from a front side and a back side, respectively;

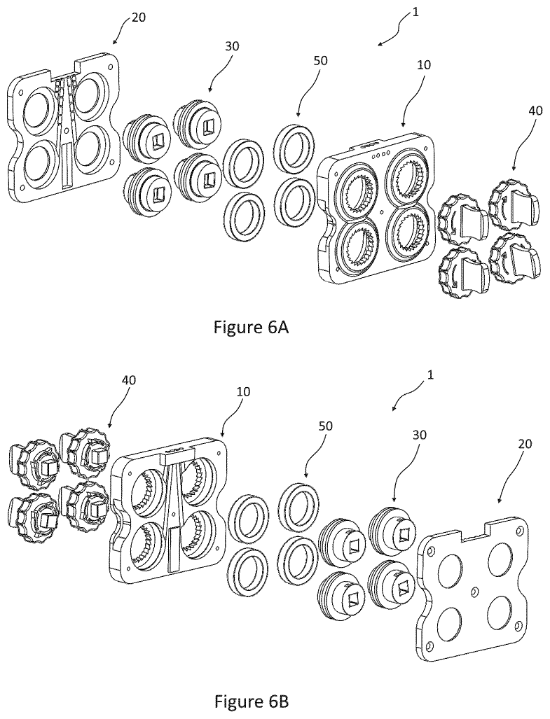

FIGS. 6A to 6B: an exploded, perspective view of an exemplary adapter unit from a front and back side, respectively;

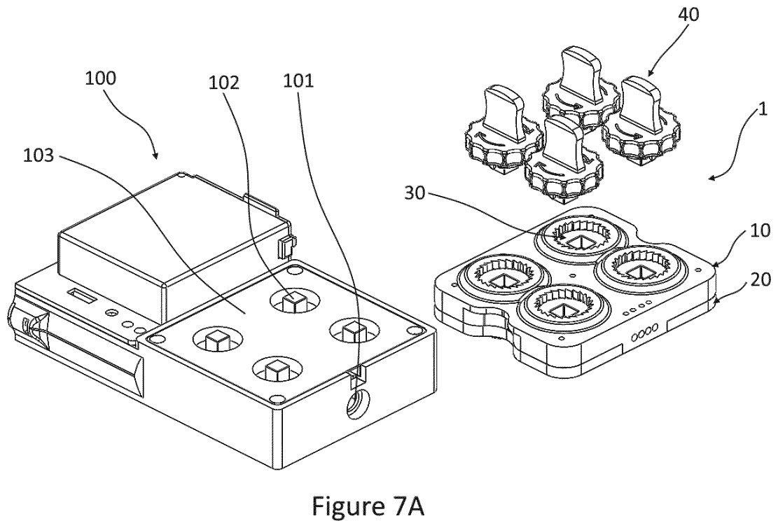

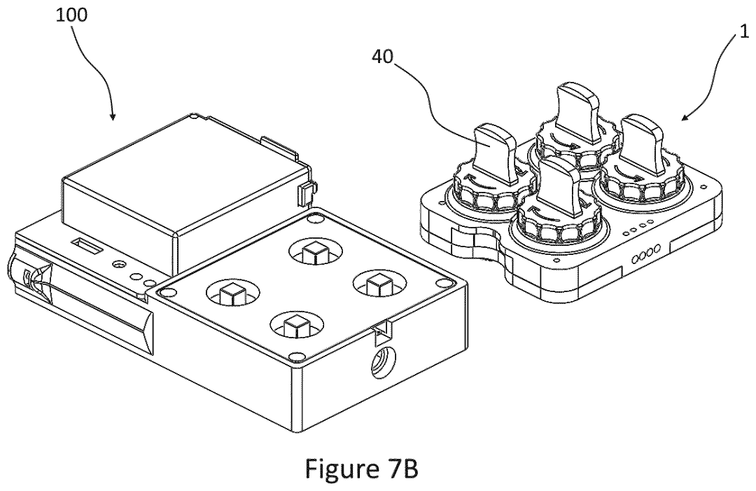

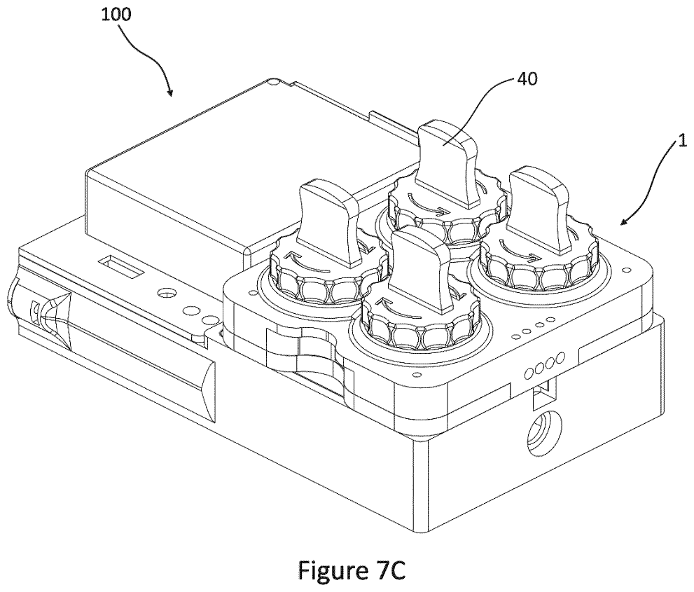

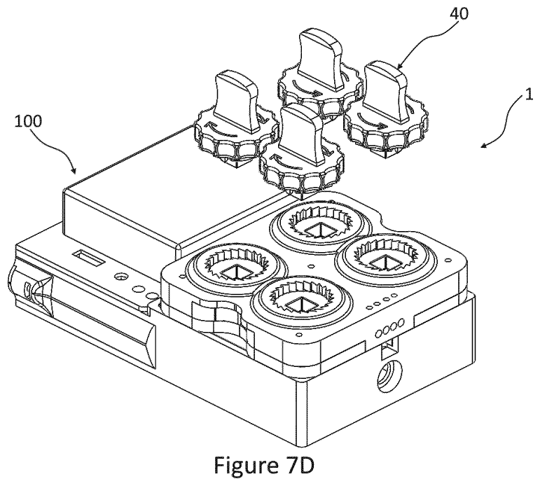

FIGS. 7A to 7D: an exemplary adapter unit in combination with an exemplary motor unit in different configurations while adjustably controlling the length of the at least one tendon;

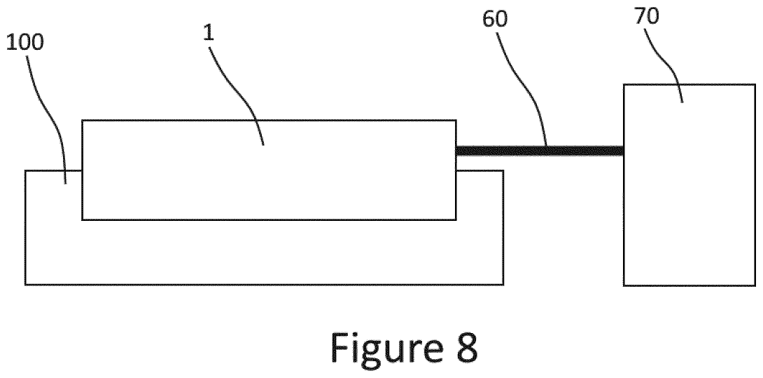

FIG. 8: an abstract, schematic overview of a tendon-driven wearable orthosis;

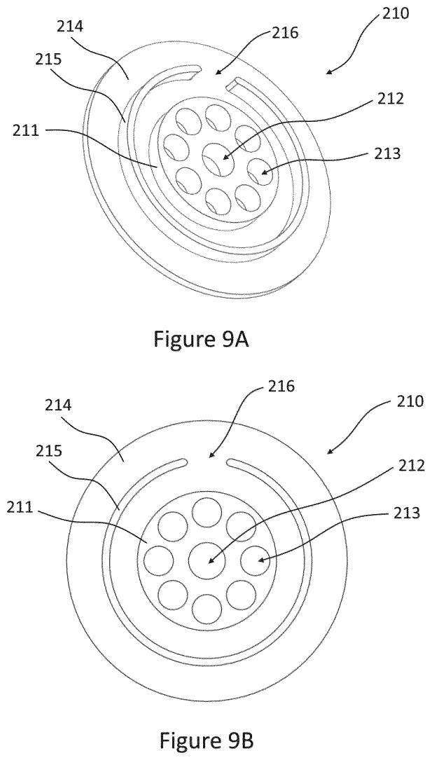

FIGS. 9A to 9B: two perspective views of an exemplary third spool of an exemplary multi-spool unit;

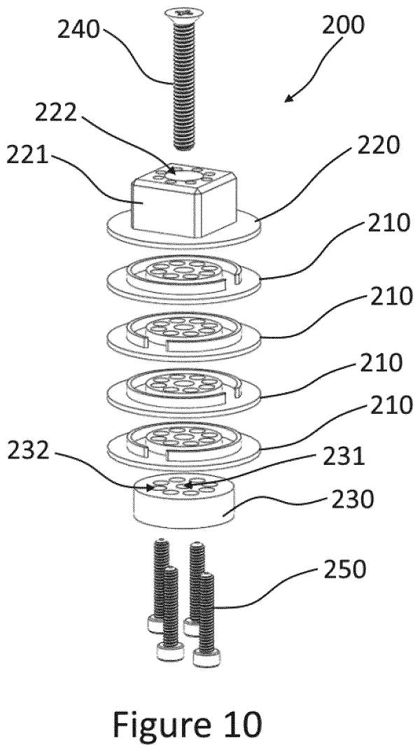

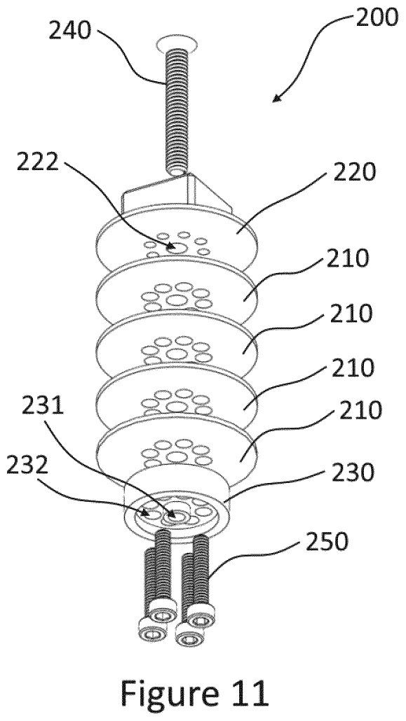

FIGS. 10 to 11: two perspective views, respectively, of an exemplary multi-spool unit;

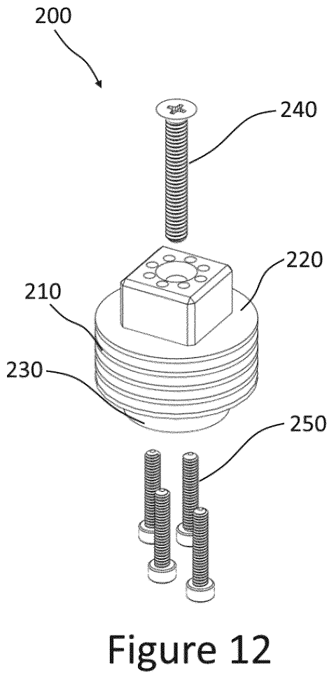

FIGS. 12 to 15: perspective views of the multi-spool unit in different configurations;

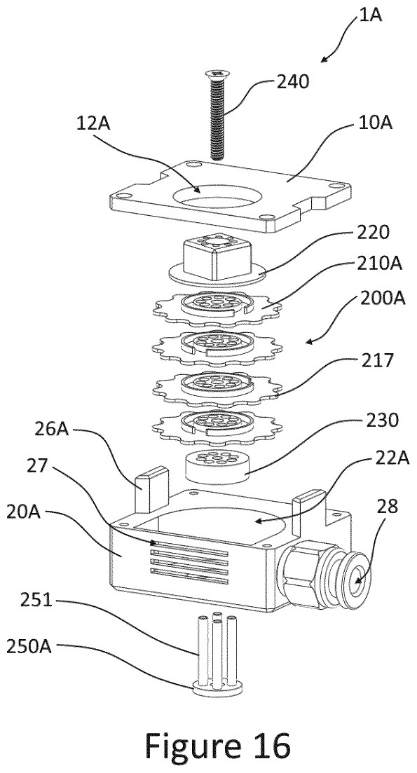

FIG. 16: a perspective, exploded view of a further exemplary adapter unit with a further multi-spool unit;

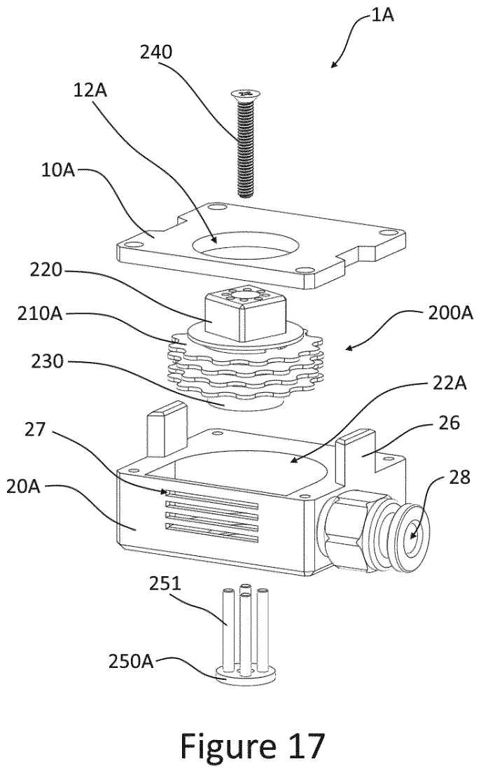

FIG. 17: a perspective, partially exploded view of a multi-spool unit and adapter unit;

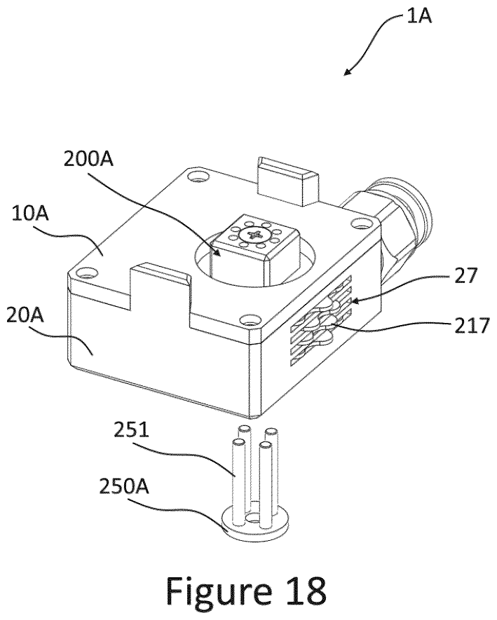

FIG. 18: a perspective view of an exemplary adapter unit;

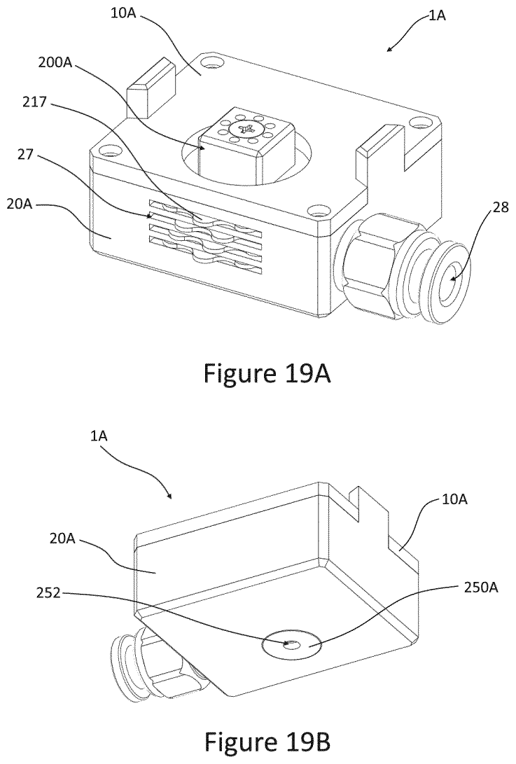

FIGS. 19A to 19B: a perspective top view and bottom view of an adapter unit, respectively;

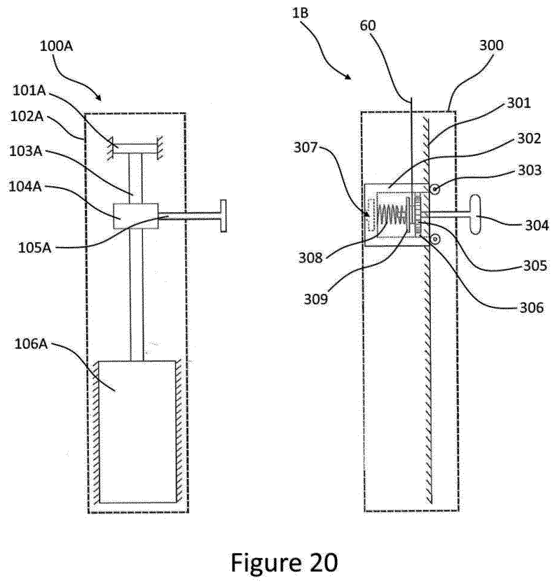

FIG. 20: a schematic side-view of a further exemplary adapter unit and exemplary motor unit;

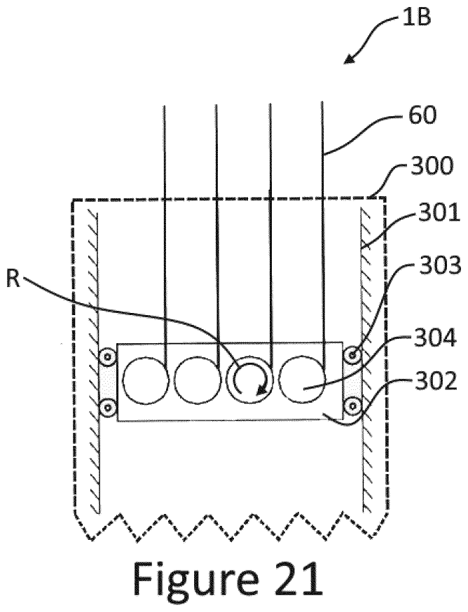

FIG. 21: a schematic top view of an exemplary adapter unit;

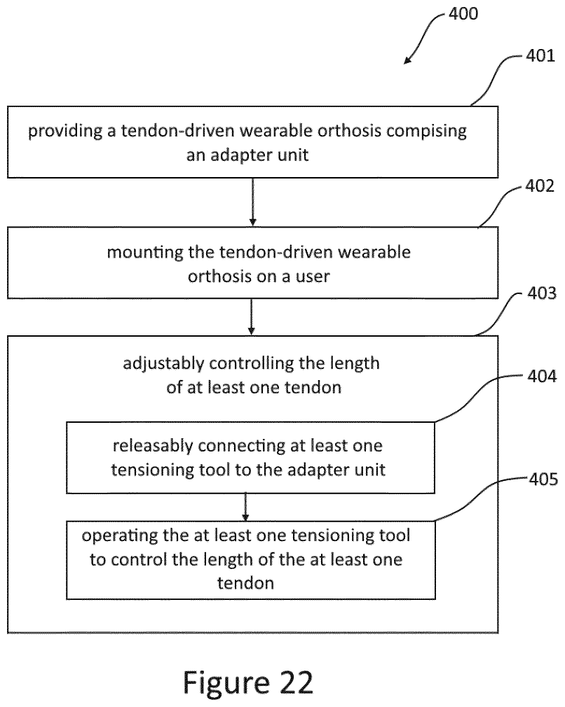

FIG. 22: a flow diagram of an exemplary method for calibrating a tendon-driven wearable orthosis configured to be worn by a user; and

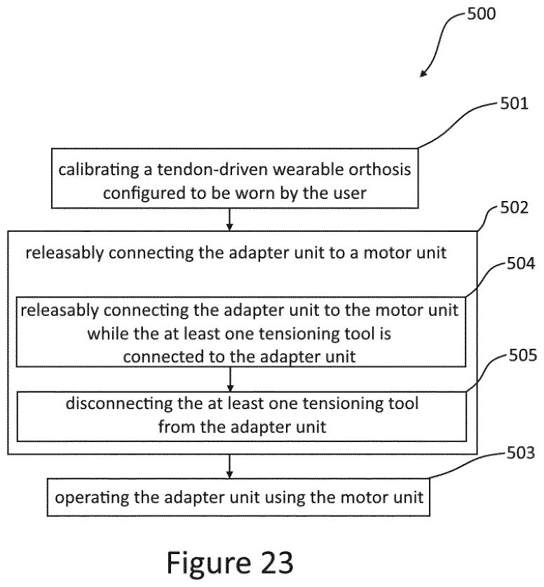

FIG. 23: a flow diagram of an exemplary method for assisting a movement of at least one joint of a user.

It is noted that in several of the following Figures, the at least one tendon and/or the at least one end effector have been omitted from illustration. This is not to be understood as restricting the scope of the disclosure. Instead, omission of the at least one tendon and/or the at least one end effector has been undertaken solely for illustrative purposes. FIG. 1 shows a top view of an exemplary adapter top plate 10 of an exemplary adapter unit 1. In particular the adapter unit 1 may comprise the adapter top plate 10 and an adapter bottom plate 20 (shown in, e.g., FIG. 3), wherein the adapter top plate 10 and the adapter bottom plate 20 may be fixed to one another to form a housing of the adapter unit 1.

The adapter top plate 10 may be substantially planar and comprise a top surface 11 and a plurality of top spool bores 12. In the present exemplary adapter top plate 10 only four top spool bores 12 are shown. It is to be understood, however, that more or less top spool bores 12 may be provided. Each of the plurality of top spool bores 12 may be configured to receive at least part of a correspondingly shaped first spool 30 (shown in, e.g., FIG. 4A). Each of the plurality of top spool bores 12 may be configured to substantially extend through the adapter top plate 10 in a direction substantially orthogonal to the top surface 11. Each top spool bore 12 may further comprise a plurality of second ratcheting teeth 13 arranged along an edge of the respective top spool bore 12 at the top surface 11. Each of the plurality of second ratcheting teeth 13 may extend at least partially along a radial direction of the respective top spool bore 12 towards the centre of said top spool bore 12. Each second ratcheting teeth 13 may further comprise a blocking contact surface substantially parallel to the radial direction and an angled contact surface substantially at a non-zero angle to said radial direction. While an exemplary shape of each of the plurality of second ratcheting teeth has been described above, it is noted that each of the plurality of first, third, and fourth ratcheting teeth may be similarly and/or correspondingly engageably shaped. However, such an exemplary shape is not to be understood as limiting. Instead, different exemplary shapes may be implemented, and may be dependent on the first, second, third, and/or fourth rotation directions.

The adapter top plate 10 may further comprise a plurality of tendon bores 14 configured to each guide at least one tendon from one or more top spool bores 12 at least partially towards at least one end effector. The tendon bores 14 may extend substantially parallel to one another and/or substantially orthogonally to the plurality of top spool bores 12. However, the disclosure is not limited to such a configuration, and different arrangements of the tendon bores 14 may be provided, such as according to individual requirements. Furthermore, the tendon bores 14 may be provided in a part of the adapter top plate 10 having a thickness larger than an average thickness of the adapter top plate 10.

Furthermore, the adapter top plate 10 may further comprise at least one top handling recess 15. The at least one top handling recess 15 may extend substantially orthogonally from a side surface of the adapter top plate 10. The at least one top handling recess 15 may be configured to facilitate handling and/or improve usability of the adapter top plate 10 and/or the adapter unit 1 by a user.

FIG. 2 shows a bottom view of an exemplary adapter top plate 10 of an exemplary adapter unit 1.

As shown in FIG. 2, the plurality of top spool bores 12 may extend through the adapter top plate from the top surface 11 to a bottom surface 16 of the adapter top plate 10. Top surface 11 and bottom surface 16 may be substantially parallel to one another. Furthermore, as illustrated in FIG. 2, the plurality of second ratcheting teeth 13 may be provided in each top spool bore 12 only in a section substantially adjacent to the top surface 11.

Furthermore, a plurality of top tendon grooves 17 may be provided in the bottom surface 16. Each top tendon groove 17 may be configured to extend from one of the top spool bores 12 to one of the tendon bores 14, and may be configured to guide a respective tendon from a top spool bore 12 to said one of the tendon bores 14.

In addition, the adapter top plate 10 may further comprise an alignment protrusion 18 extending from the bottom surface 16. While the alignment protrusion 18 shown in FIG. 2 is substantially rectangular, differently shaped alignment protrusions 18 may be provided. The alignment protrusion 18 may in particular be configured to enter into engagement with a corresponding alignment recess 26 (see, e.g., FIG. 3) of the adapter bottom plate 20 in order to align adapter top plate 10 and adapter bottom plate 20 with respect to one another.

FIG. 3 shows a top view of an exemplary adapter bottom plate 20 of an exemplary adapter unit 1.

The adapter bottom plate 20 comprises a top surface 21 and a plurality of bottom spool bores 22. In the present exemplary adapter bottom plate 20 only four bottom spool bores 22 are shown. It is to be understood, however, that more or less bottom spool bores 22 may be provided. Each of the plurality of bottom spool bores 22 may be configured to receive at least part of a correspondingly shaped first spool 30 (shown in, e.g., FIG. 4A). Each of the plurality of bottom spool bores 22 may be configured to substantially extend through the adapter bottom plate 20 in a direction substantially orthogonal to the top surface 21.

Furthermore, the plurality of top spool bores 12 and the plurality of bottom spool bores 22 may be provided such that each top spool bore 12 aligns with one bottom spool bore 22 to form a receptacle space, in which a respective first spool 30 may be accommodated and/or inserted.

A plurality of bottom tendon grooves 23 may be provided in the top surface 21. Each bottom tendon groove 23 may be configured to extend from one of the bottom spool bores 22 towards one of the tendon bores 14, and may be configured to guide a respective tendon from a bottom spool bore 22 to said one of the tendon bores 14. In particular, the plurality of top tendon grooves 17 and the plurality of bottom tendon grooves 23 may be provided such that each top tendon groove 17 aligns with a bottom tendon groove 23 to define a guide passage for a respective tendon, wherein each guide passage extends from one of the receptacle spaces to one of the tendon bores 14.

Each bottom tendon groove 23 may further comprise one or more groove protrusions 24, preferentially one or more semi-circular groove protrusions 24, arranged at one or more locations along the respective bottom tendon groove 23. By providing such groove protrusions 24, a contact area between a tendon and the respective bottom tendon groove 23 may be reduced, thereby facilitating movement of said tendon in said bottom tendon groove 23 and further reducing wear-and-tear thereon. Furthermore, it is noted that any number of groove protrusions 24 may be provided. In addition, the plurality of groove protrusions 24 may be provided in one or more of the plurality of bottom tendon grooves 23 and/or in one or more of the top tendon grooves 17.

The adapter bottom plate 20 may further comprise at least one bottom handling recess 15. The at least one bottom handling recess 25 may extend substantially orthogonally from a side surface of the adapter bottom plate 20. The at least one bottom handling recess 25 may be configured to facilitate handling and/or improve usability of the adapter bottom plate 20 and/or the adapter unit 1 by a user. Furthermore, at least one top handling recess 15 may be provided to be substantially aligned with at least one bottom handling recess 25 to form a common handling recess, when the adapter top plate 10 and the adapter bottom plate 20 are connected to one another.

The adapter bottom plate 20 may further comprise an alignment recess 26 extending from the top surface 21. The alignment recess 26 may in particular be configured to enter into engagement with a corresponding alignment protrusion 18 (see, e.g., FIG. 2) of the adapter top plate 10 in order to align adapter top plate 10 and adapter bottom plate 20 with respect to one another. The invention, however, is not limited to the exemplary alignment recess 26 and alignment protrusion 18. Instead, each of the adapter top plate 10 and the adapter bottom plate 20 may comprise one or more alignment recesses 26 and/or one or more alignment protrusions 18 in order to align the adapter top plate 10 and the adapter bottom plate 20. Furthermore, a shape of each of the alignment recesses 26 and/or of each of the alignment protrusions 18 may be freely chosen, wherein the at least one alignment recess 26 is configured to enter into engagement with at least one alignment protrusion 18 to align adapter top plate 10 and adapter bottom plate 20 with respect to one another.

FIGS. 4A and 4B show a perspective view of an exemplary first spool 30 from a front side and a back side, respectively.

The first spool 30 comprises a substantially cylindrical central rotation shaft 31 and a tendon winding section 32. The tendon winding section 32 may be arranged substantially in the middle of the central rotation shaft 31, wherein at least one tendon is connectable to the first spool 30 in the tendon winding section 32. In particular, the tendon winding section 32 may be configured such that a tendon connected thereto may be wound around at least the central rotation shaft 31 (or unwound therefrom, respectively) by rotation of the first spool 30 around the central rotation shaft 31 and/or a central rotation axis. The central rotation axis may correspond to a central axis of the central rotation shaft 31. The tendon winding section 32 may furthermore comprise a first circumferential bordering wall and a second circumferential bordering wall, wherein a tendon is connectable to the first spool 30 between the first circumferential bordering wall and the second circumferential bordering wall.

The first spool 30 may further comprise a first tensioning tool engagement section 33. The first tensioning tool engagement section 33 may be configured to be engageable with a first tensioning tool, such as a ratcheting key 40 (as shown, e.g., in FIGS. 5A and 5B). The first tensioning tool engagement section 33 may be arranged at a first end of the central rotation shaft 31, and may further be configured to be engageable with the first tensioning tool such that rotation of the first tensioning tool in engagement with the first tensioning tool engagement section 33 causes a rotation of the first spool 30 around the central rotation shaft 31 and/or the central rotation axis.

In the illustrated exemplary embodiment of the first spool 30, the first tensioning tool engagement section 33 is shown as a substantially cubic recess. However, the first tensioning tool engagement section 33 is not restricted to such an implementation. In particular, the first tensioning tool engagement section 33 may comprise one or more engagement recesses and/or one or more engagement protrusions. Furthermore, a shape of each of the one or more engagement recesses and/or one or more engagement protrusions maybe freely chosen, for example according to the specific requirements of the user.

The first spool 30 may further comprise a first motor unit engagement section 34. The first motor unit engagement section 34 may be configured to be engageable with a motor unit 100 and/or a motor unit spool engagement section 102, as for example shown in FIG. 7A. The first motor unit engagement section 34 may be arranged at a second end of the central rotation shaft 31, and may further be configured to be engageable with the motor unit 100 and/or the motor unit spool engagement section 102 such that rotation of the motor unit 100 and/or the motor unit spool engagement section 102 in engagement with the first motor unit engagement section 34 causes a rotation of the first spool 30 around the central rotation shaft 31 and/or the central rotation axis.

In the illustrated exemplary embodiment of the first spool 30, the first motor unit engagement section 34 is shown as a substantially cubic recess. However, the first motor unit engagement section 34 is not restricted to such an implementation. In particular, the first motor unit engagement section 34 may comprise one or more engagement recesses and/or one or more engagement protrusions. Furthermore, a shape of each of the one or more engagement recesses and/or one or more engagement protrusions maybe freely chosen, for example according to the specific requirements of the user.

FIGS. 5A and 5B show a perspective view of an exemplary first tensioning tool configured as an exemplary ratcheting key 40 from a front side and a back side, respectively.

The ratcheting key 40 may comprise a handle 41 provided at a first end of the ratcheting key 40, wherein the handle 41 is configured to facilitate rotation of the ratcheting key 40 round a rotation axis thereof. Please note that the handle 41 is not restricted to the arrangement and shape shown in FIGS. 5A and 5B, but may be freely chosen, such as according to specific requirements of the user.

The ratcheting key 40 may further comprise one or more rotation direction indicators 42, wherein the one or more rotation direction indicators 42 may indicate an allowed rotation direction of the ratcheting key 40 when the ratcheting key 40 is engaged with at least the adapter unit 1.

The Ratcheting Key 40 May Further Comprise a Plurality of First Ratcheting Teeth 43. the first ratcheting teeth 43 may be configured as a series of first ratcheting teeth 43 arranged circumferentially around a rotation axis of the ratcheting key 40, and may further each comprise at least one protrusion extending radially outward with respect to the rotation axis. Furthermore, each of the ratcheting teeth 43 may be configured to be elastically deformable, wherein each of the ratcheting teeth 43 may be configured to be elastically displaceable along a radial direction, such as elastically displaceable inward along the radial direction, with respect to the rotation axis.

The ratcheting key 40 may further comprise a first spool engagement section 44. The first spool engagement section 44 may be configured to be engageable with a first spool 30 and/or a first tensioning tool engagement section 33 of the first spool 30, as for example shown in FIG. 4A. The first spool engagement section 44 may be arranged at a second end of the ratcheting key 40, and may further be configured to be engageable with the first spool 30 and/or the first tensioning tool engagement section 33 of the first spool 30 such that rotation of the ratcheting key 40 in engagement with the first spool 30 and/or the first tensioning tool engagement section 33 causes a rotation of the first spool 30 around the central rotation shaft 31 and/or the central rotation axis thereof.

In the illustrated exemplary embodiment of the ratcheting key 40, the first spool engagement section 44 is shown as a substantially cubic protrusion. However, the first spool engagement section 44 is not restricted to such an implementation. In particular, the first spool engagement section 44 may comprise one or more engagement recesses and/or one or more engagement protrusions. Furthermore, a shape of each of the one or more engagement recesses and/or one or more engagement protrusions maybe freely chosen, for example according to the specific requirements of the user.

The exemplary ratcheting key 40 may be configured to be releasably engageable with the adapter unit 1 and at least one first spool 30 to bring the plurality of first ratcheting teeth 43 into engagement with at least a subset of the plurality of second ratcheting teeth 13. The plurality of first ratcheting teeth 43 and at least the subset of plurality of second ratcheting teeth 13 may be configured to prevent rotation of the at least one first spool 30 and the ratcheting key 40 in a first rotation direction and allow rotation of the at least one first spool 30 and the ratcheting key 40 in a second rotation direction opposite to the first rotation direction, while the plurality of first ratcheting teeth 43 is in engagement with at least the subset of plurality of second ratcheting teeth 13.

It is noted, however, that the first ratcheting teeth 43 according to the disclosure are not to be understood as restricted to, for example, the shown number, shape, and configuration of the ratcheting teeth 43 in FIGS. 5A and 5B.

FIGS. 6A and 6B show an exploded, perspective view of an exemplary adapter unit 1 from a front and back side, respectively.

An adapter bottom plate 20 may be provided, as for example shown in FIG. 3. The adapter bottom plate 20 may comprise at least one bottom spool bore 22.

At least one first spool 30 may be provided, as for example shown in FIGS. 4A and 4B, wherein a first spool 30 may be at least partially received in each bottom spool bore 22 of the adapter bottom plate 20.

Each first spool 30 may further comprise a spool bearing 50, wherein the spool bearing 50 may be implemented, for example, as a spool bearing washer. The spool bearing 50 may be releasably mountable on the first spool 30, such as on a central rotation shaft 31 of the first spool 30, wherein the spool bearing 50 may be provided substantially between the first spool 30 and the adapter bottom plate 20 and/or the adapter top plate 10. Although not shown in FIGS. 6A and 6B, more than one spool bearing 50 may be provided for each first spool 30.

An adapter top plate 10 may be provided, as for example shown in FIGS. 1 and 2. The adapter top plate 10 may comprise at least one top spool bore 12. Each first spool 30 and spool bearing 50 may be at least partially received in a corresponding top spool bore 12.

The adapter top plate 10 and the adapter bottom plate 20 may be fixed to one another to form a housing of the adapter unit 1. Furthermore, ratcheting keys 40 may be provided, as for example shown in FIGS. 5A and 5B. In particular, a ratcheting key 40 may be provided for each first spool 30.

FIGS. 7A, 7B, 7C, and 7D show an exemplary adapter unit 1 in combination with an exemplary motor unit 100 in different configurations while adjustably controlling the length of the at least one tendon.

The motor unit 100 may comprise a housing configured to house an actuator, such as a rotary actuator, and a drive shaft 101. The drive shaft 101 may be configured to be operable, such as rotatable, by the actuator. The drive shaft 101 may further be configured to operate and/or rotate one or more motor unit spool engagement sections 102. Each motor unit spool engagement section 102 may be configured to be engageable with a first motor unit engagement section 34 of a corresponding first spool 30.

The motor unit 100 may further comprise an adapter mounting surface 103, wherein the adapter unit 1 and/or the bottom adapter plate 20 may be mountable on the adapter mounting surface 103 such that each motor unit spool engagement section 102 enters into engagement with a corresponding first motor unit engagement section 34.

As shown in FIG. 7A, in an initial state, the adapter unit 1 is provided separate from the motor unit 100, wherein the ratcheting keys 40 are provided not in engagement with the adapter unit 1. It is noted that the tendon-driven wearable orthosis may be mounted, in a first step, on the user. For illustrative purposes, such a step is not shown in FIG. 7A.

In a second step, shown in FIG. 7B, the ratcheting keys 40 may be mounted on the adapter unit 1 to enter into engagement with the adapter unit 1 and/or the at least one first spool 30. Specifically, the ratcheting keys 40 may be mounted on the top surface 11 of the top adapter plate 10. By turning the ratcheting keys 40, the length of each tendon connected to the first spools 30 may be individually controlled and/or adjusted. For example, in the second step, the ratcheting keys 40 may be turned to adjust, preferably to reduce, the length of each tendon connected to the first spools 30 to a respective desired length.

In a third step, shown in FIG. 7C, the adapter unit 1 may be mounted on the motor unit 100, while the ratcheting keys 40 remain mounted on the adapter unit 1. In particular, it therefore is possible to maintain the adjusted and desired lengths of the at least one tendon until at least the adapter unit 1 is mounted on the motor unit 100. For example, during the third step, the ratcheting keys 40 may be further turned to adjust, preferably to further reduce, the length of each tendon connected to the first spools 30 to allow each motor unit spool engagement section 102 to enter into engagement with a corresponding first motor unit engagement section 34.

In a fourth step, shown in FIG. 7D, the ratcheting keys 40 may be removed and/or unmounted form the adapter unit 1. By removing the ratcheting keys 40, the motor unit 100 may freely operate the adapter unit 1 to exert a pulling force on the at least one tendon to assist the movement of the user.

FIG. 8 shows an abstract, schematic overview of a tendon-driven wearable orthosis. The tendon-driven wearable orthosis may comprise an adapter unit 1 and a motor unit 100, as described herein, wherein the adapter unit 1 is releasably connectable to the motor unit 100. Furthermore, the adapter unit 1 may be connectable, via at least one tendon 60, to at least one end effector 70. The adapter unit 1 may comprise the at least one tendon 60 and/or the at least one end effector 70.

FIGS. 9A and 9B show two perspective views of an exemplary third spool 210 of an exemplary multi-spool unit 200.

The third spool 210 may comprise a cylindrical central section 211, wherein the cylindrical central section 211 may comprise a central mounting bore 212. The cylindrical central section 211 may further comprise one or more locking bores 213, wherein the one or more locking bores 213 may be arranged adjacent to the central mounting bore 212.

The one or more locking bores 213 may be configured as a single locking bore 213 (not shown in FIGS. 9A and 9B) or as a plurality of locking bores 213, wherein the plurality of locking bores 213 may be arranged, and preferentially equally spaced, to circularly surround the central mounting bore 212. The central mounting bore 212 and the one or more locking bores 213 may further extend substantially parallel to one another through the cylindrical central section 211.

The third spool 210 may further each comprise a, preferably circular, mounting plate 214 extending from the cylindrical central section 211 outwards. The mounting plate 214 may be substantially planar and orthogonal to a central axis of the central mounting bore 212. The mounting plate 214 may further comprise a circumferential wall 215, wherein the circumferential wall 215 is configured to extend orthogonally from the mounting plate 214 and at least partially surround the cylindrical central section 211. The circumferential wall 215 may comprise at least one opening 216, wherein the opening 216 is configured to allow at least one tendon, fixed to the cylindrical central section 211, to pass through the circumferential wall 215. Each third spool 210 may be configured such that, during rotation of the third spool 210 around a central rotation shaft 240 (see, e.g., FIG. 10), a tendon fixed to the respective cylindrical central section 211 may be wound around the circumferential wall 215.

The mounting plate 214, the circumferential wall 215, and at least one of: an adjacent mounting plate 214 of a further third spool 210 mounted adjacent to the exemplary third spool 210, the top plate 220, and the bottom plate 230, may be configured to form a tendon channel for at least one tendon fixed to the cylindrical central section 211. Specifically, the tendon channel may be configured such that, during rotation of the exemplary third spool 210, a tendon fixed to the respective cylindrical central section 211 may be wound around the circumferential wall 215 within the tendon channel.

FIGS. 10 and 11 show two perspective views, respectively, of an exemplary multi-spool unit 200.

The multi-spool unit 200 may comprise at least a central rotation shaft 240 and a plurality of third spools 210 mountable on the central rotation shaft 240. Each third spool 210 may be mountable on the central rotation shaft 240 substantially adjacent to at least one other third spool 210. The central rotation shaft 240 may be implemented as a central shaft screw. Each third spool 210 may comprise a central mounting bore 212 extending through the respective third spool 210, wherein the central rotation shaft 240 is insertable into the central mounting bore 212. Each third spool 210 may be configured as a third spool 210 shown in FIGS. 9A and 9B. Furthermore, the plurality of third spools 210 may be substantially identical to one another, or the plurality of third spools 210 may comprise two or more third spools 210 different to one another.

The multi-spool unit 200 may further comprise a top plate 220 mountable on the central rotation shaft 240. The top plate 220 may comprise a central top plate mounting bore 222 extending through the top plate 220, wherein the central rotation shaft 240 is insertable into the central top plate mounting bore 222. The top plate 220 may further comprise one or more top plate locking bores configured to be releasably engageable with a third tensioning tool 250. Furthermore, the top plate 220 may in addition comprise a top plate motor engagement section 221, wherein the top plate motor engagement section 221 may be configured to be engageable with a motor unit to allow the motor unit to operate, preferentially to rotate, the multi-spool unit 200. A shape of the top plate motor engagement section 221 may be chosen according to, for example, the specific requirements of the user and/or the motor unit.

The multi-spool unit 200 may further comprise a bottom plate 230 mountable on the central rotation shaft 240. The bottom plate 230 may comprise a central bottom plate mounting bore 231 extending through the bottom plate 230, wherein the central rotation shaft 240 is insertable into the central bottom plate mounting bore 231. The central rotation shaft 240 may be engageable with the central bottom plate mounting bore 231, such as by screwing the central rotation shaft 240 into the central bottom plate mounting bore 231. Furthermore, the plurality of third spools 210 may be mountable on the central rotation shaft 240 between the top plate 220 and the bottom plate 230. Specifically, the central rotation shaft 240 may be engageable with the central bottom plate mounting bore 231, to press the top plate 220 and the bottom plate 230 together, thereby generating a compression force and/or squeezing force on the plurality of third spools 210.

In particular, the multi-spool unit 200 may be configured to be switchable between a first state and a second state. In the first state, each of the plurality of third spools 210 may be configured to be rotatable, preferentially freely rotatable, around the central rotation shaft 240. In the second state, the plurality of third spools 210 may be configured to be fixed relative to the central rotation shaft 240 by compressing the plurality of third spools 210 between the top plate 220 and the bottom plate 230. In the second state, the multi-spool unit 200 may be configured to be rotatable by the motor unit to exert the pulling force on the at least one tendon.

The bottom plate 230 may further comprise one or more bottom plate locking bores 232 configured to be releasably engageable with at least one third tensioning tool 250. The at least one third tensioning tool 250 may be implemented as at least one locking screw, wherein each locking screw may be engageable with at least one bottom plate locking bore 232. In addition, the bottom plate 230 may further comprise a recess configured to at least partially receive the at least one third tensioning tool 250, such as for example a screw head of the at least one locking screw.

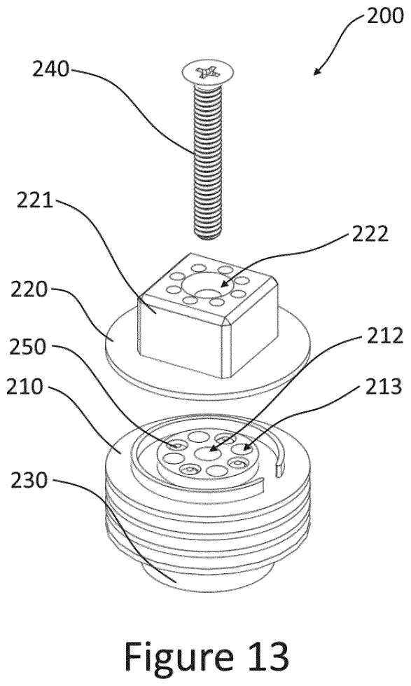

The at least one third tensioning tool 250 may be configured to be releasably engageable with the plurality of third spools 210 in at least the first state to fix an orientation of the plurality of third spools 210 relative to one another. A third tensioning tool 250 may for example be configured to be inserted into a bottom plate locking bore 232 of the bottom plate 230 and a locking bore 213 of each of the plurality of third spools 210 to fix an orientation of the plurality of third spools 210 relative to one another. Such a configuration has been illustrated, for example, in FIG. 13, wherein the top plate 220 and the central rotation shaft 240 have been illustratively displaced to enable a clearer view.

The at least one third tensioning tool 250 may be removable from the multi-spool unit 200 in the second state, wherein a compressive force generated by pressing the top plate 220 and bottom plate 230 together, as described above, may be sufficient to prevent a rotation of the third spools 210 relative to one another in the second state. Alternatively, the at least one third tensioning tool 250 may be maintained in the multi-spool unit 200 in the second state to ensure no relative rotation between the plurality of third spools 210.

FIG. 12 shows a partially assembled view of the multi-spool unit 200. In the shown view, the top plate 220, the plurality of third spools 210, and the bottom plate 230 are arranged adjacent to one another in a stack configuration, while the central rotation shaft 240 and the at least one third tensioning tool 250 are illustrated separately form the stack configuration.

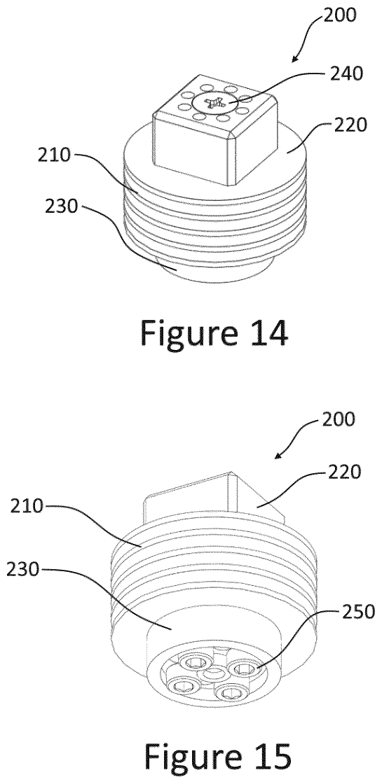

FIGS. 14 and 15 show two perspective views of a multi-spool unit 200 according to one of FIGS. 10 to 13 in a fully assembled configuration.

FIG. 16 shows a perspective, exploded view of a further exemplary adapter unit 1A with a further multi-spool unit 200A.

The adapter unit 1A may comprise a top plate 10A, wherein the top plate 10A may be substantially planar. A multi-spool unit recess 12A may be provided in the top plate 10A and configured to at least partially receive and/or accommodate the multi-spool unit 200A.

The adapter unit 1A may further comprise a bottom plate 20A. The bottom plate 20A may comprise a multi-spool accommodation space 22A configured to at least partially accommodate the multi-spool unit 200A. The multi-spool unit recess 12A and the multi-spool accommodation space 22A may be configured to form a substantially closed accommodation space, in which the multi-spool unit 200A may be accommodated. Furthermore, the top plate 10A and the bottom plate 20A may be configured to form a housing for the multi-spool unit 200A. The bottom plate 20A may further comprise one or more alignment posts 26A configured to at least partially engage the top plate 10A to align the top plate 10A with respect to the bottom plate 20A.

In addition, the bottom plate 20A may further comprise a tendon outlet 28, wherein the tendon outlet 28 is configured to guide one or more tendons connected to the multi-spool unit 200A from within the multi-spool accommodation space 22A through the bottom plate 20A towards the at least one end effector. The tendon outlet 28 may be implemented, for example, as one or more outlet bores in the bottom plate 20A.

The multi-spool unit 200A may further comprise a central rotation shaft 240, a top plate 220, and a bottom plate 230 substantially similar to the central rotation shaft 240, the top plate 220, and the bottom plate 230, respectively, as described for the multi-spool unit 200 above. A duplicate description thereof will therefore be omitted. Similar to the multi-spool unit 200, the multi-spool unit 200A may be switchable between the first state and the second state.

The multi-spool unit 200A may further comprise a plurality of third spools 210A, wherein the plurality of third spools 210A may be configured similar to the plurality of third spools 210, as described for the multi-spool unit 200 above. However, each third spool 210A may differ from the third spools 210 described above in the provision of additional gripping protrusions 217. Each third spool 210A may comprise a plurality of such gripping protrusions 217 arranged around the circumference of the mounting plate 214 and/or the third spool 210A.

The plurality of gripping protrusions 217 may be configured to facilitate the rotation of each third spool 210A, such as for example by the user. Furthermore, the bottom plate 20A may comprise a plurality of access slits 27 through the bottom plate 20A arranged adjacent the multi-spool accommodation space 22A. Each access slit 27 may be configured and arranged to at least partially accommodate the plurality of gripping protrusions 217 of a third spool 210A when the multi-spool unit 200A is accommodated within the multi-spool accommodation space 22A. In particular, the plurality of gripping protrusions 217 may therefore at least partially extend from the multi-spool accommodation space 22A through the access slits 27 when the multi-spool unit 200A is accommodated within the multi-spool accommodation space 22A. Thereby, it is easily possible to rotate, for example by hand, each third spool 210A without having to unmount the top plate 10A and bottom plate 20A from one another.

The multi-spool unit 200A may further differ from the multi-spool unit 200 in the provision of a different third tensioning tool 250A. The third tensioning tool 250A may be integrally formed. In particular, the third tensioning tool 250A may comprise a plurality of locking protrusions 251, wherein each locking protrusion 251 may be configured to be engageable with a bottom plate locking bore 232 of the bottom plate 230 and a locking bore 213 of each of the plurality of third spools 210A in order to fix the orientation of the plurality of third spools 210A with respect to one another.

FIG. 17 shows a perspective, partially exploded view of the multi-spool unit 200A and adapter unit 1A.

In particular, as shown in FIG. 17, the top plate 220, the plurality of third spools 210A, and the bottom plate 230 are arranged adjacent to one another in a stack configuration, while the central rotation shaft 240 and the at least one third tensioning tool 250A are illustrated separately form the stack configuration.

FIG. 18 shows a perspective view of the adapter unit 1A, wherein the top plate 10A and the bottom plate 20A are fixed to one another to accommodate the multi-spool unit 200A. In the shown adapter unit 1A, the multi-spool unit 200A is in the first state and the third tensioning tool 250A is illustrated separately.

Furthermore, FIG. 18 shows a plurality of gripping protrusions 217 of the at least one third spool 210A extending through the plurality of access slits 27. In particular, the plurality of gripping protrusions 217 may extend through the plurality of access slits 27 and protrude at least partially from the bottom plate 20A to be accessible from outside the adapter unit 1A.

FIGS. 19A and 19B show a perspective top view and bottom view of the adapter unit 1A, respectively. In particular, the adapter unit 1A is shown fully assembled, wherein the third tensioning tool 250A is brought into engagement with the multi-spool unit 200A in order to fix the orientation of the plurality of third spools 210A with respect to one another.

The third tensioning tool 250A may be configured to be flush with a bottom surface of the bottom plate 20A when in engagement with the multi-spool unit 200A. The third tensioning tool 250A may further comprise an access bore 252. An access key (not shown) may be provided, wherein the access key may be configured to be engageable with the access bore 252 to remove the third tensioning tool 250A from the multi-spool unit 200A. Alternatively, the third tensioning tool 250A may be provided with a handle (not shown) to allow removal of the third tensioning tool 250A from the multi-spool unit 200A.

FIG. 20 shows a schematic side-view of a further exemplary adapter unit 1B and exemplary motor unit 100A, while FIG. 21 shows a schematic top view of the exemplary adapter unit 1B.

The adapter unit 1B and/or the at least one tensioning device may comprise a spool carriage 302 movably mounted on a carriage track 301. The spool carriage 302 and the carriage track 301 may be provided in a housing 300 of the adapter unit 1B. The spool carriage 302 may comprise a carriage body and at least one wheel element 303, wherein the at least one wheel element 303 is fixed to the carriage body and configured to allow the spool carriage 302 to be movable along the carriage track 301. The carriage track 301 may comprise two guide rails (as seen, for example, in FIG. 21), along which the spool carriage 302 may be guided. In the presented exemplary embodiment, the spool carriage 302 may comprise at least two wheel elements 303 for each guide rail.

The at Least One Tensioning Device May Further Comprise at Least One Second Spool 309 (e.g., four second spools 309, as shown in FIG. 21) mounted on the spool carriage 302, wherein the at least one tendon 60 is connectable to the at least one second spool 309. The at least one second spool 309 may be mounted on the spool carriage 302 to be rotatable in a rotation direction R (see, e.g., FIG. 21) around a central rotation axis of the at least one second spool 309. One tendon 60 may be at least partially woundable around each second spool 309 by rotation of the respective second spool 309.

The spool carriage 302 may further comprise a plurality of third ratcheting teeth 306 provided in the spool carriage body of the spool carriage 302. Each second spool 309 may comprise a plurality of fourth ratcheting teeth 305 releasably engageable with at least a subset of the plurality of third ratcheting teeth 306. The plurality of fourth ratcheting teeth 305 and at least the subset of plurality of third ratcheting teeth 306 may be configured to prevent rotation of each second spool 309 in a third rotation direction and allow rotation of each second spool 309 in a fourth rotation direction (e.g., rotation direction R) opposite to the third rotation direction, while the plurality of fourth ratcheting teeth 305 is in engagement with at least the subset of plurality of third ratcheting teeth 306.

The at least one tensioning device may further comprise at least one second tensioning tool 304, wherein each second tensioning tool 304 may be releasably engageable with one second spool 309. In particular, the at least one second spool 309 may be configured to be rotatable in the rotation direction R using the at least one second tensioning tool 304 to control the length of the at least one tendon 60 between the adapter unit 1B and the at least one end effector.

The at least one second spool 309 may be further configured to be operable using the at least one second tensioning tool 304 to move the plurality of fourth ratcheting teeth 305 out of engagement with at least the subset of the plurality of third ratcheting teeth 306. In particular, the at least one second spool 309 may comprise a spring element 308. Specifically, each second spool 309 may thereby be configured as a second spring-loaded spool. The at least one spring element 308 may be fixed at a first spring end to the spool carriage 302 and/or the carriage body, and/or may be fixed at a second spring end to the at least one second spool 309. A pressing force may be exerted on the second tensioning tool 304 engage with the at least one second spool 309 to cause the at least one spring element 308 to be compressed, thereby moving the plurality of fourth ratcheting teeth 305 out of engagement with at least the subset of the plurality of third ratcheting teeth 306.

The spool carriage 302 may further be configured to be movable along the carriage track 301 by the motor unit 100A to exert the pulling force on the at least one tendon 60.

The motor unit 100A may comprise a motor element 106A and a spindle 103A. The spindle 103A may be connected, at a first end thereof, to the motor element 106A and may be connected, at a second end thereof, to a bearing element 101A. A sled 104A may be provided on the spindle 103A, wherein the motor unit 106A may be configured to operate, e.g., to rotate, the spindle 103A in order to move the sled 104A linearly along the spindle 103A. The motor unit 106A, the spindle 103A, the sled 104A, and the bearing element 101A may be provided in a motor unit housing 102A.

The adapter unit 1B and/or the spool carriage 302 may further comprise a keyed motor engagement section 307, and the motor unit 100A and/or the sled 104A may comprise a keyed connection post 105A. The keyed connection post 105A may be configured to be engageable with the keyed motor engagement section 307 when the adapter unit 1B is connected to the motor unit 100A to allow the motor unit 100A to move the spool carriage 302 along the carriage track 301.

FIG. 22 shows a flow diagram of an exemplary method 400 for calibrating a tendon-driven wearable orthosis configured to be worn by a user.

In a first step 401, the method 400 may comprise providing the tendon-driven wearable orthosis. The tendon-driven wearable orthosis may be configured to assist a movement of at least one joint of the user, and comprise an adapter unit connectable, via at least one tendon, to at least one end effector. The tendon-driven wearable orthosis may comprise any combination of features, as disclosed for a tendon-driven wearable orthosis herein.

In a second step 402, the method 400 may further comprise mounting the tendon-driven wearable orthosis on the user. Mounting the tendon-driven wearable orthosis on the user may comprise, for example, at least partially wearing the tendon-driven wearable orthosis by the user.

In a third step 403, the method 400 may further comprise adjustably controlling, by for example using at least one tensioning device of the adapter unit, a length of the at least one tendon between the adapter unit and the at least one end effector.

The third step 403 may further comprise a fourth step 404 of releasably connecting at least one tensioning tool to the adapter unit.

The third step 403 may further comprise a fifth step 405 of operating, such as for example by rotating and/or turning, the at least one tensioning tool to control the length of the at least one tendon between the adapter unit and the at least one end effector.

FIG. 23 shows a flow diagram of an exemplary method 500 for assisting a movement of at least one joint of a user. The method 500 may comprise, as a first step 501, calibrating a tendon-driven wearable orthosis configured to be worn by the user. In particular, the first step 501 may comprise performing the method 400 for calibrating a tendon-driven wearable orthosis described herein.

In a second step 502, the method 500 may comprise releasably connecting the adapter unit to a motor unit configured to operate the adapter unit to exert a pulling force on the at least one tendon to assist the movement of the at least one joint of the user. In a third step 503, the method 500 may comprise operating the adapter unit using the motor unit.

The second step 502 may further comprise, in a fourth step 504, releasably connecting the adapter unit to the motor unit while the at least one tensioning tool is connected to the adapter unit.

The second step 502 may in addition also comprise, in a fifth step 505, disconnecting the at least one tensioning tool from the adapter unit.

As readily understood from the present disclosure, while the invention has been described by means of exemplary embodiments illustrated in the appended Figures, the invention is not limited thereto. Instead, any combination of features described herein and/or shown in the appended Figures may be implemented.

### LIST OF REFERENCE NUMERALS

1, 1A, 1B Adapter unit
10, 10A Adapter top plate
20, 20A Adapter bottom plate
11 Top surface
12 Top spool bore
13 Second ratcheting teeth
14 Tendon bore
15 Top handling recess
16 Bottom surface
17 Top tendon groove
18 Alignment protrusion
21 Top surface
22 Bottom spool bore
23 Bottom tendon groove
24 Groove protrusion
25 Bottom handling recess
26 Alignment recess
30 First spool
31 Central rotation shaft
32 Tendon winding section
33 First tensioning tool engagement section
34 First motor unit engagement section
40 Ratcheting key
41 Handle
42 Rotation direction indicator
43 First ratcheting teeth
44 First spool engagement section
50 Spool bearing
60 Tendon
70 End effector
100, 100A Motor unit
101 Drive shaft
102 Motor unit spool engagement section
103 Adapter mounting surface
101A Bearing element
102A Motor unit housing
103A Spindle
104A Sled
105A Keyed connection post
106A Motor element
200, 200A Multi-spool unit
210, 210A Third spool
211 Cylindrical central section
212 Central mounting bore
213 Locking bore
214 Mounting plate
215 Circumferential wall
216 Opening
240 Central rotation shaft
220 Top plate
230 Bottom plate
221 Top plate motor engagement section
222 Central top plate mounting bore
231 Central bottom plate mounting bore
232 Bottom plate locking bore
250, 250A Third tensioning tool
12A Multi-spool unit recess
22A Multi-spool accommodation space
26A Alignment post
27 Access slit
28 Tendon outlet
217 Gripping protrusion
251 Locking protrusion
252 Access bore
300 housing
301 Carriage track
302 Spool carriage
303 Wheel element
304 Second tensioning tool
305 Fourth ratcheting teeth
306 Third ratcheting teeth
307 Keyed motor engagement section
308 Spring element
309 Second spool
R Rotation direction
400 Method (for calibrating a tendon-driven wearable orthosis)
401-405 Steps
500 Method (for assisting a movement of at least one joint of a user)
501-505 Steps

1. A tendon-driven wearable orthosis configured to be worn by a user, wherein the tendon-driven wearable orthosis is configured to assist a movement of at least one joint of the user, comprising:
an adapter unit (1, 1A, 1B) connectable, via at least one tendon (60), to at least one end effector (70),
wherein the adapter unit (1, 1A, 1B) is releasably connectable to a motor unit (100, 100A), wherein the motor unit (100, 100A) is configured to operate the adapter unit (1, 1A, 1B) to exert a pulling force on the at least one tendon (60) to assist the movement of the at least one joint,
wherein the adapter unit (1, 1A, 1B) comprises at least one tensioning device configured to adjustably control a length of the at least one tendon (60) between the adapter unit (1, 1A, 1B) and the at least one end effector (70).

2. The tendon-driven wearable orthosis according to claim 1, wherein the tendon-driven wearable orthosis is configured to assist a movement of at least one finger joint of a hand of the user, and, optionally,
wherein the movement of at least one finger joint is a flexion and/or extension of the at least one finger joint.

3. The tendon-driven wearable orthosis according to claim 1, wherein the tendon-driven wearable orthosis further comprises the at least one tendon (60) and the at least one end effector (70); and/or
wherein the at least one tensioning device is configured to adjustably control the length of the at least one tendon (60) between the adapter unit (1, 1A, 1B) and the at least one end effector (70) while the adapter unit (1, 1A, 1B) is not connected to the motor unit (100, 100A).

4. The tendon-driven wearable orthosis according to claim 1, wherein the adapter unit (1, 1A, 1B) further comprises at least one first spool (30), wherein the at least one tendon (60) is connectable to the at least one first spool (30),
wherein the at least one first spool (30) is configured to be rotatable by the motor unit (100, 100A) to exert the pulling force on the at least one tendon (60).

5. The tendon-driven wearable orthosis according to claim 4, wherein the at least one tensioning device comprises at least one first tensioning tool releasably engageable with the adapter unit (1, 1A, 1B) and the at least one first spool (30),
wherein the at least one first spool (30) is configured to be operable using the at least one first tensioning tool to control the length of the at least one tendon (60) between the adapter unit (1, 1A, 1B) and the at least one end effector (70).

6. The tendon-driven wearable orthosis according to claim 5, wherein the at least one first tensioning tool is at least one ratcheting key (40),
wherein each ratcheting key (40) comprises a plurality of first ratcheting teeth (43) and the adapter unit (1, 1A, 1B) comprises a plurality of second ratcheting teeth (13),
wherein each ratcheting key (40) is configured to be releasably engageable with the adapter unit (1, 1A, 1B) and at least one first spool (30) to bring the plurality of first ratcheting teeth (43) into engagement with at least a subset of the plurality of second ratcheting teeth (13),
wherein the plurality of first ratcheting teeth (43) and at least the subset of plurality of second ratcheting teeth (13) are configured to prevent rotation of the at least one first spool (30) in a first rotation direction and allow rotation of the at least one first spool (30) in a second rotation direction opposite to the first rotation direction, while the plurality of first ratcheting teeth (43) is in engagement with at least the subset of plurality of second ratcheting teeth (13).

7. The tendon-driven wearable orthosis according to claim 1, wherein the at least one tensioning device comprises:
a carriage movably mounted on a carriage track (301),
at least one connection device mounted on the carriage, wherein the at least one tendon (60) is connectable to the at least one connection device,
wherein the carriage is configured to be movable along the carriage track (301) by the motor unit (100, 100A) to exert the pulling force on the at least one tendon (60).

8. The tendon-driven wearable orthosis according to claim 7, wherein the carriage is a spool carriage (302),
wherein the at least one connection device is at least one second spool (309).

9. The tendon-driven wearable orthosis according to claim 8, wherein the spool carriage (302) comprises a plurality of third ratcheting teeth (306),
wherein the at least one second spool (309) comprises a plurality of fourth ratcheting teeth (305) releasably engageable with at least a subset of the plurality of third ratcheting teeth (306),
wherein the plurality of fourth ratcheting teeth (305) and at least the subset of plurality of third ratcheting teeth (306) are configured to prevent rotation of the at least one second spool (309) in a third rotation direction and allow rotation of the at least one second spool (309) in a fourth rotation direction opposite to the third rotation direction, while the plurality of fourth ratcheting teeth (305) is in engagement with at least the subset of plurality of third ratcheting teeth (306).

10. The tendon-driven wearable orthosis according to claim 9, wherein the at least one tensioning device comprises at least one second tensioning tool (304) releasably engageable with the at least one second spool (309),
wherein the at least one second spool (309) is configured to be rotatable in the fourth direction using the at least one second tensioning tool (304) to control the length of the at least one tendon (60) between the adapter unit (1, 1A, 1B) and the at least one end effector (70),
wherein the at least one second spool (309) is configured to be operable using the at least one second tensioning tool (304) to move the plurality of fourth ratcheting teeth (305) out of engagement with at least the subset of the plurality of third ratcheting teeth (306).

11. The tendon-driven wearable orthosis according to claim 1, wherein the at least one tensioning device further comprises a multi-spool unit (200, 200A), wherein the multi-spool unit (200, 200A) comprises:
a central rotation shaft (240),
a plurality of third spools (210, 210A) mounted on the central rotation shaft (240), wherein the at least one tendon (60) is connectable to the plurality of third spools (210, 210A),
wherein the multi-spool unit (200, 200A) is configured to be switchable between a first state and a second state,
wherein, in the first state, each of the plurality of third spools (210, 210A) is configured to be rotatable around the central rotation shaft (240),
wherein, in the second state, the plurality of third spools (210, 210A) is configured to be
wherein, in the second state, the multi-spool unit (200, 200A) is configured to be rotatable by the motor unit (100, 100A) to exert the pulling force on the at least one tendon (60).

12. The tendon-driven wearable orthosis according to claim 11, wherein the at least one tensioning device comprises at least one third tensioning tool (250, 250A),
wherein the at least one third tensioning tool (250, 250A) is configured to be releasably engageable with the plurality of third spools (210, 210A) in the first state to fix an orientation of the plurality of third spools (210, 210A) relative to one another.

13. The tendon-driven wearable orthosis according to claim 5, wherein the adapter unit (1, 1A, 1B) is configured to be connectable to the motor unit (100, 100A) and the at least one first tensioning tool, the at least one second tensioning tool (304), or the at least one third tensioning tool (250, 250A), respectively, at the same time.

14. A method (400) for calibrating a tendon-driven wearable orthosis configured to be worn by a user, wherein the tendon-driven wearable orthosis is configured to assist a movement of at least one joint of the user, wherein the tendon-driven wearable orthosis comprises an adapter unit (1, 1A, 1B) connectable, via at least one tendon (60), to at least one end effector (70), the method comprising:
mounting the tendon-driven wearable orthosis on the user;
adjustably controlling, using at least one tensioning device of the adapter unit (1, 1A, 1B), a length of the at least one tendon (60) between the adapter unit (1, 1A, 1B) and the at least one end effector (70).

15. The method (400) for calibrating a tendon-driven wearable robot according to claim 14, wherein the adjustably controlling a length of the at least one tendon (60) comprises:
releasably connecting at least one tensioning tool to the adapter unit (1, 1A, 1B),
operating, using the at least one tensioning tool, the at least one tensioning device to control the length of the at least one tendon (60) between the adapter unit (1, 1A, 1B) and the at least one end effector (70).
